(19) United States
(12) Patent Application Publication
(10) Pub. No.: US 2008/0059776 A1
(43) Pub. Date: Mar. 6, 2008

(54) Compression method for instruction sets

(76) Inventors: Chih-Ta Star Sung, Glonn (DE); Yin-Chun Blue Lan, Wurih Township (TW)

Correspondence Address: Chih-Ta Star SUNG, RM. 308, BLD. 52, NO. 195,, CHUNG HSING RD., SEC. 4,, JHU DONG TOWNSHIP, HSINCHU COUNTY, 310, omitted

(21) Appl. No.: 11/515,986

(22) Filed: Sep. 6, 2006

(51) Int. Cl. G06F 9/44

(52) U.S. Cl. 712/226

(57) ABSTRACT

A compression method and apparatus compresses the instruction for a CPU which significantly reduces the density of storage device of storing the program. Multiple groups of instructions are compressed separately by a mapping unit indicating the starting location of a group of instructions which helps quickly recovering the corresponding instructions. In decoding, multiple instructions are decoded in parallel to quickly recover instructions to avoid running out of instruction in the file register. A mapping unit is used to translate the corresponding address of a group of data for quickly recovering the corresponding data for the file register file to avoid running out of data for a CPU to execute.

### BACKGROUND OF THE INVENTION

1. Field of Invention

The present invention relates to the data compression and decompression method and device, and particularly relates to the program memory within a CPU which results in a die area reduction and higher performance.

2. Description of Related Art

In the past decades, the continuous semiconductor technology migration trend has driven wider and wider applications including internet, the digital image and video, digital audio and display. Consumer electronic products consume high amount of semiconductor components including digital camera, video recorder, 3G mobile phone, VCD, DVD, Set-top-box, Digital TV, . . . etc.

Some products are implemented by hardware devices, while, another high percentage of product functions and applications are realized by executing a software or firmware program embedded within a CPU, Central Processing Unit or a DSP, Digital Signal Processing engine.

Advantage of using software and/or firmware to implement desired functions includes flexibility and better compatibility with wider applications by re-programming. While, the disadvantage includes higher cost of storage device of program memory which store a large amount of instructions of execution for a specific function. For example, a hard wire designed ASIC block of a JPEG decoder might costs only 40,000 logic gate, while a total of 128,000 Byte of execution code might be needed for executing the decompression function of JPEG picture decompression which is equivalent to about 1 M bits and 3M logic gate if all instructions are stored on the CPU chip. If a complete program is stored in a program memory, or so called “I-Cache” (Instruction Cache), the memory density might be too high. If partial program is stored in the I-cache, when cache missed, the time of moving the program from an off-chip to the on-chip CPU might cost long delay time and higher power will be dissipated in I/O pad data transferring.

This invention of the instruction sets compression reduced the required density of cache memory which overcomes the disadvantage of the existing CPU with less density of caching memory and higher performance when cache miss happens and also reduces the times of transferring data from an off-chip program memory to the on-chip cache memory and saves power consumption.

### SUMMARY OF THE INVENTION

The present invention of the high efficiency data compression method and apparatus significantly reduces the requirement of the memory density of the program memory and/or data memory of a CPU.

The present invention reduces the requirement of density of the program memory of a CPU by compressing the instruction sets.

When a CPU is executing a program, the I-cache decompression engine of this invention decodes the compression instruction and fills into the “File Register” for CPU to execute the appropriate instruction with corresponding timing.

According to an embodiment of the present invention, the compressed instruction set are saved in the predetermined location of the storage device and the starting address of group of compressed instructions is saved in another predetermined location.

According to an embodiment of the present invention, multiple compressed instructions are buffered and the decoder recovers the instruction with variable length of time each instruction and temporarily stores them into a buffer and filling to the “File Register” for the CPU to execute.

According to an embodiment of the present invention, a predetermined amount of instructions are accessed and decompressed and buffered to ensure that the “File Register” will not run short of instruction in executing a program.

According to an embodiment of the present invention a dictionary like storage device is used to store the pattern not shown in previous pattern.

According to an embodiment of the present invention, a comparing engine receives the coming instruction and searches for a matching instruction in the previous instructions.

According to an embodiment of the present invention, a mapping unit calculates the starting location of a group of instruction for quickly recovering the corresponding instruction sets.

Other aspects and advantages of the present invention will become apparent from the following detailed description, taken in conjunction with the accompanying drawings, illustrating by way of example the principles of the invention. It is to be understood that both the foregoing general description and the following detailed description are by examples, and are intended to provide further explanation of the invention as claimed.

### BRIEF DESCRIPTION OF THE DRAWINGS

FIG. 1 illustrates a prior art of the data flow of a CPU.

FIG. 2 shows the principle of the invention of compression instruction and data going to a CPU.

FIG. 3 illustrates a basic concept of compressing a group of instructions into fixed length or variable length of bits.

FIG. 4 illustrates the compressed instruction data followed by the bit rate information and the address of starting point of each group of instruction.

FIG. 5 shows the procedure of decoding the starting location with an image frame by calculating the bit rate of each line and the starting address of each group of lines.

FIG. 6 illustrates Procedure of Decoding a program and filling the file register for CPU execution.

FIG. 7 illustrates Block diagram of compressing and decompressing the instruction with an address mapping unit.

FIG. 8 illustrates the block diagram of how the compression engine with the starting address of a group of instruction and output control signals.

FIG. 9 illustrates how the control signals and data/addr bus are interfacing to the storage device.

### DESCRIPTION OF THE PREFERRED EMBODIMENTS

Due to the fact that the performance of the semiconductor technology has continuously doubled every around 18 months since the invention of the transistor, wide applications including internet, wireless LAN, digital image, audio and video becomes feasible and created huge market including mobile phone, internet, digital camera, video recorder, 3G mobile phone, VCD, DVD, Set-top-box, Digital TV, . . . etc. Some electronic devices are implemented by hardware devices, some are realized by CPU or DSP engines by executing the software or the firmware completely or partially embedded inside the CPU/DSP engine. Due to the momentum of semiconductor technology migration, coupled with short time to market, CPU and DSP solution becomes more popular in the competitive market.

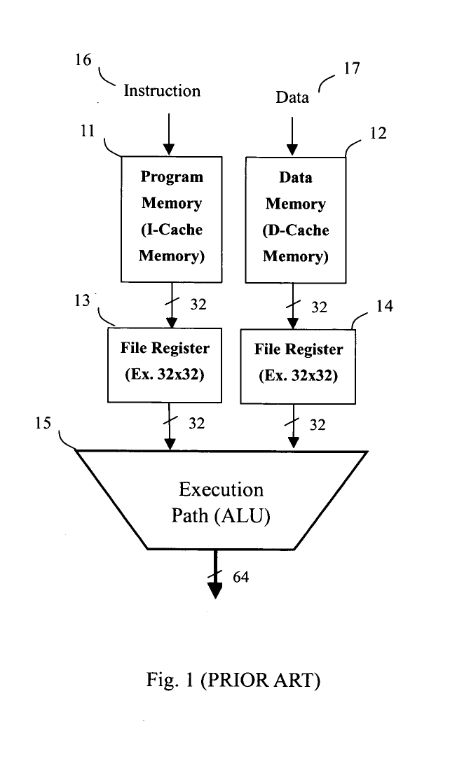

Different applications require variable length of programs which in some cases should be partitioned and part of them be stored in an on-chip “cache memory” since transferring instructions from an off-chip to the CPU causes long delay time and consumes high power. Therefore, most CPUs have a storage device called cache memory for buffering execution code of the program and the data. The cache used to store the program comprising of instruction sets is also named “Instruction Cache” or simply named “I-Cache” while the cache storing the data is called “Data Cache” or “D-Cache”. FIG. 1 shows the prior art principle of how a CPU executes a program. A program is comprised a certain amount of “Instruction” sets 16 and data sets 17 which are the sources and codes of the CPU execution. An “Instruction” instructs the CPU what to work on. The instructions of program are saved in an on-chip program memory, or so called I-Cache memory 11, while the corresponding data which a program needs to execute are saved in an on-chip data memory, or so called D-Cache memory 12. The “Caching Memory” might be organized to be large bank with heavy capacitive loading and relatively slow in accessing compared to the execution speed of the CPU execution logic, therefore, another temporary buffer of so named “File Register” 13, 14 with most likely smaller size, for example 32×32 (32 bits wide instruction or data times 32 rows) is placed between the CPU execution path 15 and the caching memory. The CPU execution path will have some basic ALU functions like AND, NAND, OR, NOR, XOR, Shift, Round, Mod . . . etc, some might have multiplication and data packing and aligning features.

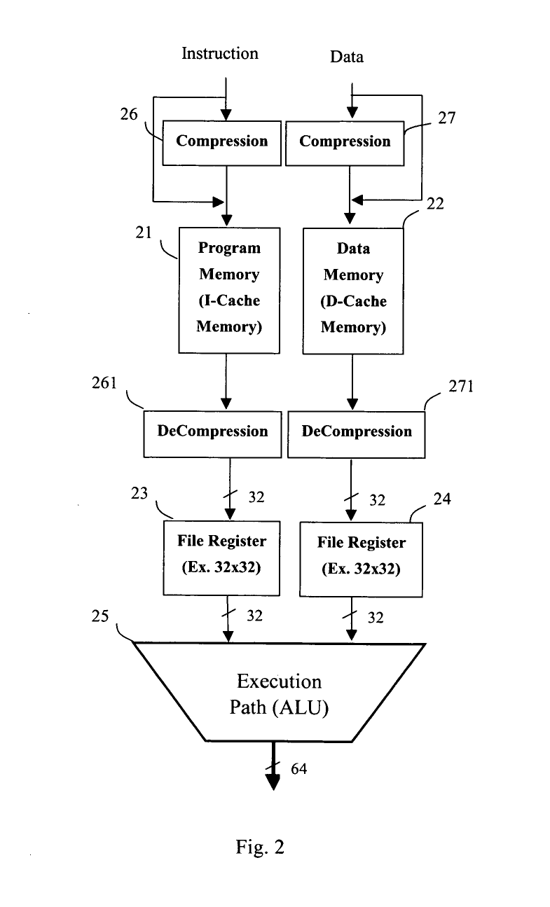

Since the program memory and data memory costs high percentage of die area of a CPU in most applications, this invention reduces the required density of the program and/or data memory by compressing the CPU instructions and data. The key procedure of this invention is illustrated in FIG. 2. The instruction and/or data is compressed 26, 27 before being stored into the program memory 21 and data memory 22. When a scheduled time matched for executing the program or data, the compressed instruction and/or data is decompressed 261, 271 and fed to the file register 23, 24 which is a smaller temporary buffer next to the execution unit 25 of the CPU. The instruction or data can also be compressed by other machine before being fed into the CPU engine. If the coming instruction or data is compressed before, then, the compressed instruction or data can bypass the compression step and directly feeds to the program/data memory, said the I-cache and D-cache.

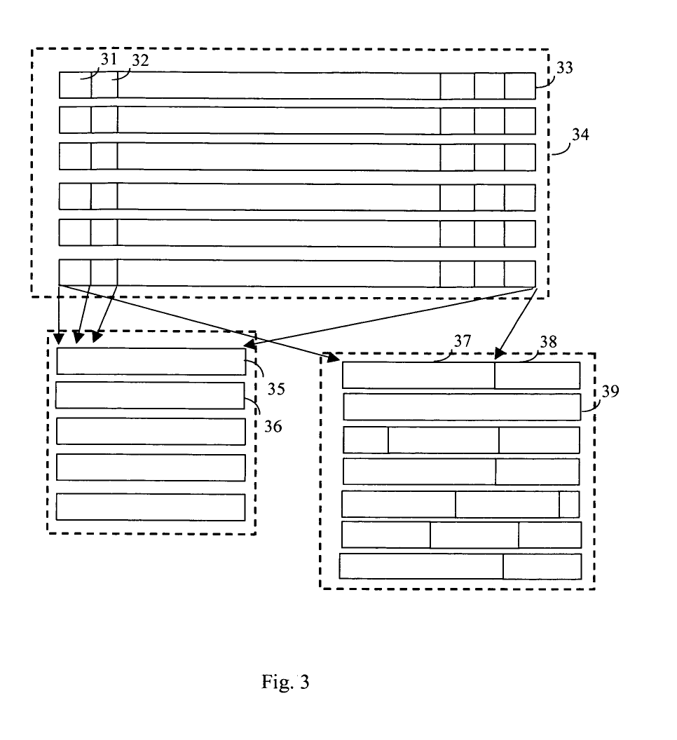

In this invention, the program of instruction sets is compressed before saving to the cache memory. Some instructions are simple, some are complex. The simple instruction can be compressed also in pipelining, while some instructions are related to other instructions' results and require more computing times of execution. Decompressing the compressed program saved in the cache memory also has variable length of computing times for different instructions. The more instruction sets are put together as a compression unit, the higher compression rate will be reached. FIG. 3 depicts the concept of compressing a fixed length of groups of instructions 31, 32, 33 which together form a program 34. A group of predetermined amount of instructions can be compressed to be fixed length of code 35, 36 or be variable length of each group 37, 38, 39. A group of instruction sets in this invention is comprised of amount of instruction sets ranging widely from 16 instructions to a couple of thousands of instructions depending on the targeted application.

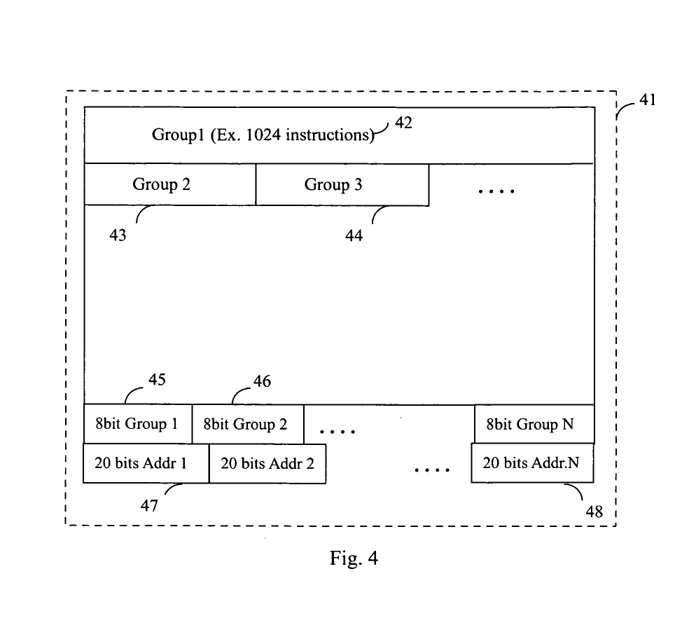

FIG. 4 illustrates the method of organizing the compressed instructions. The compressed instruction data 41 with variable bit rate of each group, for example, a couple of groups of instructions 42, 43, 44 are saved into a storage device from a predetermined location. For accelerating the accessing and decompression speed, a predetermined counter is used to calculate the bit rate of each group 45, 46 and to save it in the temporary register for recording and tracking the starting address in the storage device for each group of instructions. During accessing compressed instructions saved in the corresponding location, the instruction of the starting address 47, 48, 49 of a group of instructions will be extracted and decompressed firstly and be used as reference for reconstructing the rest of instructions within the group.

For saving the hardware, a predetermined amount of groups of instructions shares one starting address of the storage device which saves the compressed instructions. Each group of compressed instructions can have a predetermined length of code to represent the bit rate. For example, a 8 bits code 45, 46 represents 2 times compression (=2048 bits) plus/minus one of (128, 64, 32, 16, 8, 4, 2, 1) bits with predetermined definition. So, the code representing the relative length of each group saves some bits compared to the complete code representing the address of storage device which also save hardware in implementation. In some applications, when a full address representing the location of each group of compressed instructions is not critical, applying code to represent address of each location of group of instructions is applicable. The starting address will be saved into the predetermined location within the storage device which saves the compressed instructions data as well.

A new instruction of the program is compared to the previous instructions to decide whether a match happens. If a match happens, the corresponding previous instruction is used to represent the current instruction. If no matching, the current instruction can still be compressed by information within itself by some compression methods including but not limited to the “Run-Length” coding, entropy coding, . . . etc. A dictionary like buffer with predetermined amount of bits is designed to store the previous instructions. To achieve higher compression rate, the previous instructions are compressed before being saved to the buffer. And will be decompressed again before output to be compared to the new instruction. Theoretically, the larger the buffer, the more instructions it can save and the higher probability it can find a matching instruction from. So, there will be tradeoff in most applications in determining the size of the buffer of storing previous instructions.

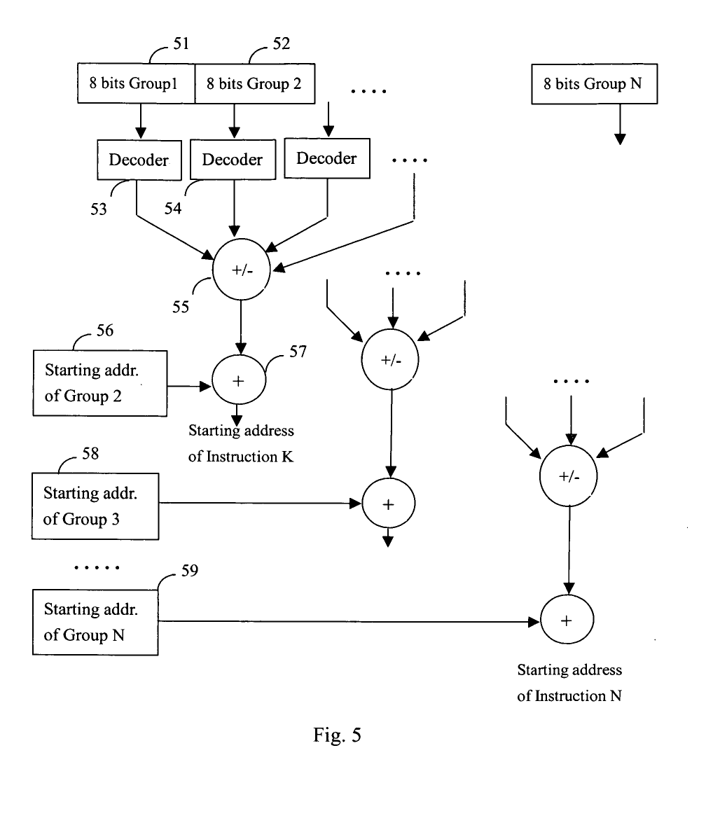

FIG. 5 illustrates the procedure of decoding the starting address of each group of the compressed instructions saved in the storage device. The bit rate decoders 53, 54 calculate 55 the length of each group 51, 52 of instructions and adds 57 with the starting address 56, 58, 59 of a couple of groups of compressed instructions will come out of the exact location of the starting or said first of a group of compressed instructions. In most hardware including IC implementation, it takes about 1 or 2 clock cycle of time to decode and calculate the starting location of any group of the compressed instruction and access the starting instruction for reference of other instructions.

In some applications of this invention of I-cache and/or D-cache memory compression, a program or data sets can be compressed by the built-in on-chip compressor, some can be done by other off-chip CPU engine. Both ways of compressing the instruction or data, the compressed program and data set can be saved in the cache memory and decompressed by an on-chip decompression unit. Some instructions random access other instruction or location, for instance, “Jump”, “Go To”, for achieving higher performance, a predetermined depth of buffer or named FIFO (First in, first out), for example, 32×16 bits is design to temporarily store the instructions, and send the instruction to the compressor for compression. For random accessing the instruction and quickly decoding the compressed instructions, the compressor compresses the instructions with each group of instruction with a predetermine length and the compressed instructions are buffered by a buffer before being stored to the cache memory.

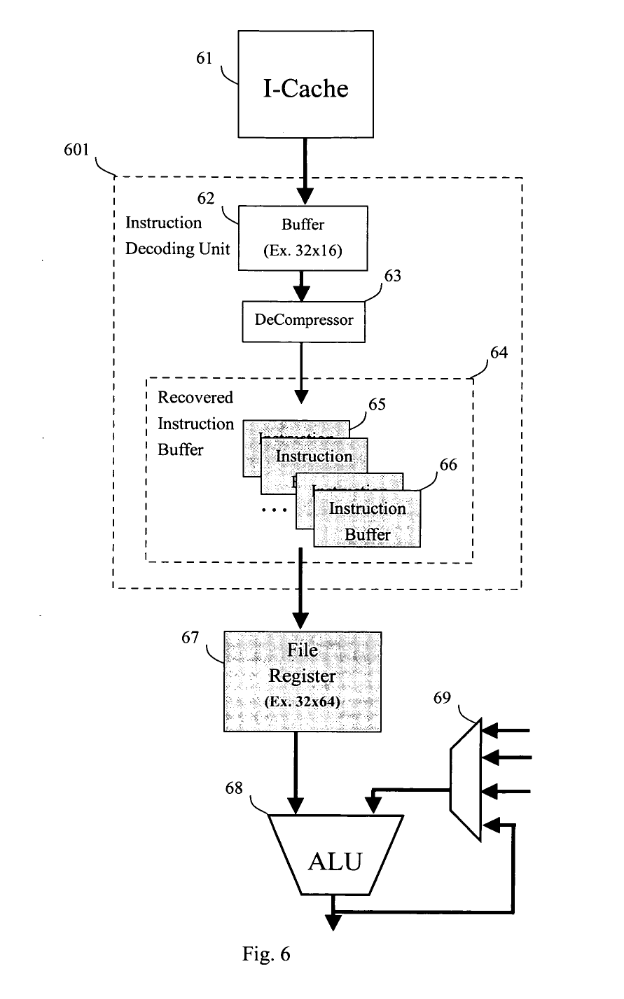

FIG. 6 shows the procedure of decompressing the instructions and filling the “File Register” for execution. The compressed instructions stored in the I-Cache memory 61 is input to the DeCompressing unit 601 which includes a predetermined amount of buffer 62, for instance, a 32×16 bits, a DeCompressor 63 and a predetermined amount of the buffer 65, 66 of recovered instructions 64 or so named FIFO. The recovered instructions are fed into the “File Register” 67 which a temporary buffer before the execution path, or so names ALU, Arithmetic and Logic Unit 68. Some instructions wait the result of previous instruction and combine other data which is selected by a multiplexer 69 to determine which data to be fed to the execution unit again.

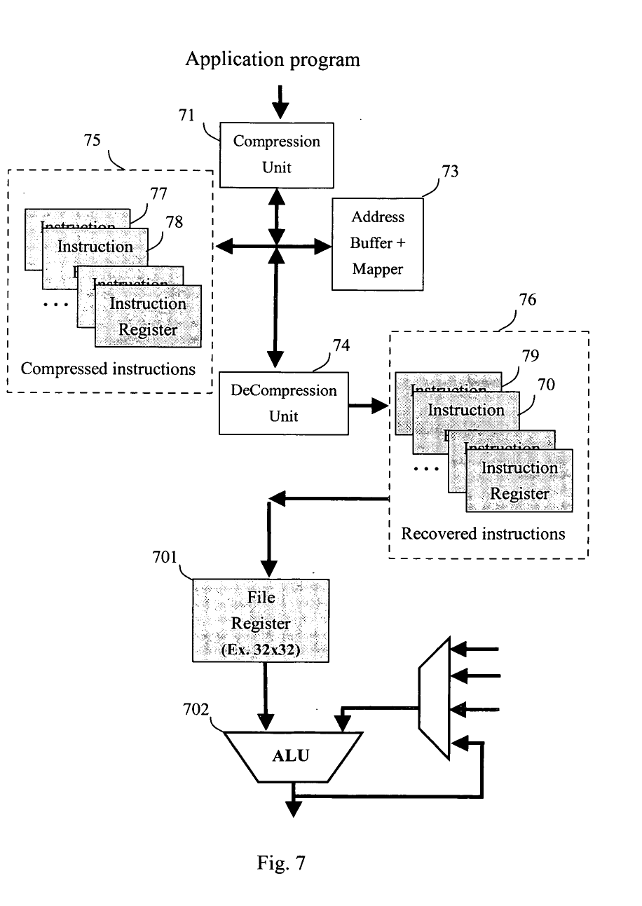

A complete procedure of compressing and decompressing the instruction set within a CPU is depicted in FIG. 7. An application program with uncompressed instruction sets is compressed 71 and stored into the so named “I-cache” 75 with a predetermined amount of groups of compressed instructions. During compressing, a counter calculates the data rate of each group of compressed instruction and converts it to be starting address of the I-cache memory and saved in an address mapping buffer 73. During decompressing, the compressed instruction sets are accessed by calculating the starting address which is done by the address mapping unit 73. The calculated starting address of a group of instructions will be then accessed and instruction sets are decompressed 74 and temporarily saved in a register array 76 for feeding to the file register 701 in a scheduled timing. The depth of the temporary buffer for saving the decompressed instructions 70, 79 is defined jointly with the file register to ensure the ALU 702 will continuously running instructions without underflow the file register.

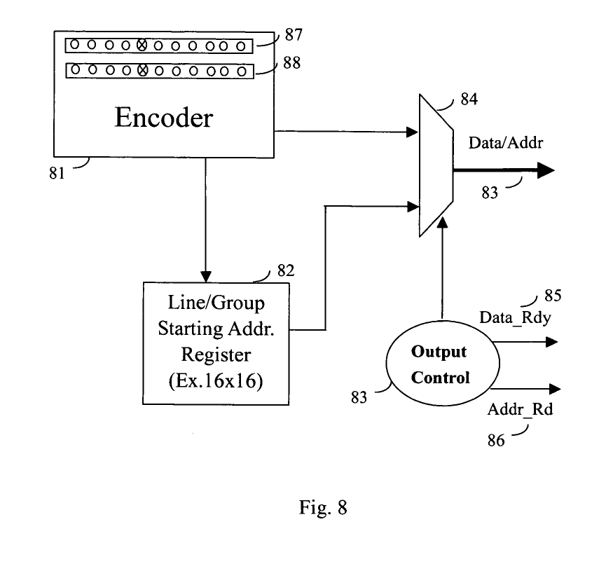

The address can be stored in the address mapping unit or embedded into the I-cache memory. For storage device or said the I-cache to be easier in saving the compressed instruction data and starting address of identifying each group of compressed instruction sets, the compressed instructions and starting address can be saved in predetermined different location. In a hardware implementation of compressing the application program as shown in FIG. 8, a compression engine 81 with counters calculating bit rate 87, 88 of group of instructions are combined with a register temporary saving the starting address 82 of group of instructions. The starting address and the compressed instruction data can share the same output bus 83 with a MUX 84 as a output selector or separately output to the targeted storage device. A control unit 83 generates the selection signal as well as sending out two enable signals 85. 86 to indicate the availability of compressed instructions data or starting address. With the valid data on the data/addr bus along with the “Data-Rdy” (data ready) or “Addr-Rdy” (Address ready) signals, the storage device will save the data or address in separate location without confusion.

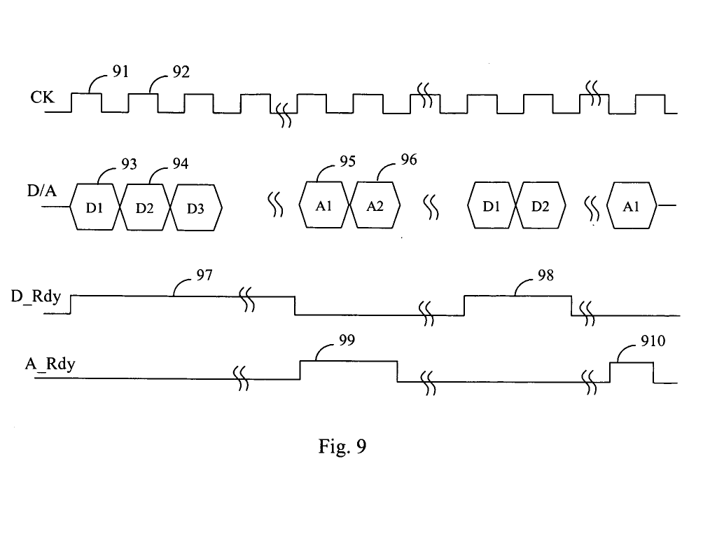

FIG. 9 shows the timing diagram of the handshaking of the data-addr and control signals of the compression engine. The valid data 93, 94 or address 95, 96 are output by most likely a burst mode with D-Rdy (data valid) 97, 98 and A-Rdy (Address valid) 99, 910 signals with active high enabling. All signals and data are synchronized with the clock 91, 92. With this kind of handshaking mechanism, the storage device or said the I-cache will clearly understand the type and timing of the valid data and starting address of the groups of instructions. The temporary register saving the starting address can be overwritten after the stored address information is sent out to the I-cache. By scheduling outputting the starting address and overwriting the register by new starting address of new groups of compressed instructions, the density of the temporary register can be minimized.

It will be apparent to those skills in the art that various modifications and variations can be made to the structure of the present invention without departing from the scope or the spirit of the invention. In the view of the foregoing, it is intended that the present invention cover modifications and variations of this invention provided they fall within the scope of the following claims and their equivalents.

What is claimed is:

1. A method of executing instruction sets of a CPU, comprising:
compressing the instruction sets group by group with at least 2 groups of instructions having different compressed data rates and storing the compressed instruction into a predetermined location of the first storage device;
calculating the data rate of each compressed group of instructions, converting to the starting location of the first storage device which saves the compressed instructions and saving the starting location of each compressed group of instructions into another predetermined location of the first storage device;
fetching the compressed instructions from the first storage device by firstly calculating the location of the first storage device which stores the compressed group of instructions and decompressing the compressed instructions; and
writing the decompressed instructions into the second storage device which directly connect to the CPU for execution.

2. The method of claim 1, wherein the instruction sets can be compressed by other CPU engine by using the similar compression method before being input to another CPU.

3. The method of claim 1, wherein multiple instructions can be compressed and decompressed in parallel and saved in temporary registers as a group of instructions which share the starting address of the storage device.

4. The method of claim 1, wherein a temporary storage device comprising of a predetermined amount of registers is used to buffer the decompressed instructions for continuously filling the second storage device for CPU to directly execute the program without running out of instruction.

5. The method of claim 1, wherein during accessing a group of compressed instructions, the starting location is accessed firstly, followed by accessing the codes representing the length of the groups of compressed instructions and the final location of the first compressed instruction saved in the storage device can be calculated and accessed accordingly.

6. The method of claim 1, wherein in compressing an uncompressed program, a temporary storage device comprising of multiple registers are used to buffer the compressed instructions and store to the first storage device which has higher density than the second storage device.

7. The method of claim 1, wherein in compressing an uncompressed program, a new instruction is compared to previous instructions saved in a storage device to determine if a previous instruction can be used to represent the current instruction.

8. The method of claim 1, wherein in compressing an uncompressed program, if current instruction finds no identical one from previous instructions, the current instruction is compressed by information of itself and saves into the instruction buffer which temporarily stores previous instructions.

9. The method of claim 1, wherein when cache miss happens in executing a program within a CPU, other instructions stored in other device are transferred to the CPU, if the instructions is compressed it is stored to the cache memory, if uncompressed, it is compressed and stored to the cache memory.

10. A method for compressing instruction sets with fast accessing and decompressing instructions within a group of compressed instructions saved in the storage device, comprising:
reducing the data rate of instructions group by group by referring current instruction to a temporary buffer which saved previous instructions to check whether there is an instructions which is identical to the current instruction and using it to represent the current instruction, if no identical instruction in the instruction register, then, compressing the instruction by information of itself and saving the current instruction into the instruction register;
driving out and conducting at least two signals to the storage device to indicate which output data from the compression unit is the compressed data and which is the starting address of a group of instruction and saving the compressed instructions data into the predetermined location and the starting address of at least one group of compressed instructions into another location of the storage device; and
when continuously accessing and decompressing the compressed instructions, the address mapping unit calculates the starting address of the corresponding group of the compressed instructions and decompressing the instructions and feeding to the file register for execution.

11. The method of claim 10, wherein a register temporarily used to save the starting address of groups of compressed instructions can be overwritten by new starting address once the starting address of previous group of instructions are output to the storage device.

12. The method of claim 10, wherein saving the compressed instructions into a predetermined location with burst mode of data transferring mechanism and saving the starting address of groups of instructions into another location with the control signals indicating which cycle time has compressed instruction data or starting address on the bus.

13. The method of claim 10, wherein there are at least two signals, one indicating “Data ready” another for “Starting address ready” being connected to the storage device to indicate which type of data are on the bus.

14. The method of claim 10, wherein a mapping unit calculating the starting location of a group of compressed instructions for more quickly recovering the corresponding instructions is comprised a translator which adds the starting address and the decoded length of group or sub-group of instructions to be the exact starting location of the storage device which saves the compressed instructions.

15. The apparatus of claim 10, wherein during decompressing instructions correlating to other instructions, a corresponding group of compressed instructions are accessed and decompressed through the translation of the address mapping unit.

16. The method of claim 10, wherein the compressed instructions data are burst and saved in the predetermined location of the storage device and the starting address of group of instructions is saved from another predetermined location of the storage device.

17. The method of claim 10, wherein, at least two groups of compressed instructions have different length of bits.

18. The method of claim 10, wherein, if “cache miss” happens, the compressed instructions saved in the second storage device are transferred to the storage device within the current CPU.

19. The method of claim 10, wherein, if “cache miss” happens, the uncompressed instructions saved in the second storage device are transferred and compressed firstly before being saved to the storage device within the current CPU.
